(19) United States
(12) Patent Application Publication
(10) Pub. No.: US 2019/0259298 A1
(43) Pub. Date: Aug. 22, 2019

(54) SYSTEMS, METHODS, AND SOFTWARE FOR IMPLEMENTING A BEHAVIOR CHANGE MANAGEMENT PROGRAM

(71) Applicant: Microsoft Technology Licensing, LLC, Redmond, WA (US)

(72) Inventors: Sreeram Nivarthi, Redmond, WA (US); Nagendra Kalyan Nanduru, Redmond, WA (US); Leanna Holly Robb, Seattle, WA (US); Noelle Renee Beaujon, Seattle, WA (US); Jayasekera Mudhiyanselage Vindana Madhuwantha, Bothell, WA (US); Vineet Batta, Bothell, WA (US); Xinyun Sun, Kirkland, WA (US); Omar Suhaib Mustafa, Bellevue, WA (US); Andrew Christian Owen, Bellevue, WA (US); Di Li, Bellevue, WA (US); Chantrelle Nielsen, Seattle, WA (US); Nina Shikaloff, San Rafael, CA (US); Shrey Arun Shah, Bellevue, WA (US); Ghyara Firdosh Rohinton, Bellevue, WA (US); Stefani Bartz, Seattle, WA (US); Eric Kurt Radtke, Eagle, WI (US); MIchael Senkow, Seattle, WA (US)

(21) Appl. No.: 15/944,439

(22) Filed: Apr. 3, 2018

Related U.S. Application Data
(60) Provisional application No. 62/631,811, filed on Feb. 18, 2018.

(51) Int. Cl. G09B 19/00; G06Q 10/10; G09B 5/02

(52) U.S. Cl. CPC G09B 19/00; G09B 5/02; G06Q 10/103

(57) ABSTRACT

A behavior change management service to create and deploy a behavior change management program. The behavior change management service processes productivity service data associated with users of a productivity service application to identify individuals a similar collaboration issue. The behavior change management service further creates a behavior change management program based on the identified collaboration issue; deploys the behavior change management program to the identified individuals; and monitors, tracks, and reports each individual's progress during the behavior change management program.

### RELATED APPLICATIONS

This application is related to, and claims the benefit of priority to, U.S. Provisional Application No. 62/631,811, filed on Feb. 18, 2018, and entitled SYSTEMS, METHODS, AND SOFTWARE FOR IMPLEMENTING A BEHAVIOR CHANGE MANAGEMENT PROGRAM, which is hereby incorporated by reference in its entirety.

### TECHNICAL BACKGROUND

Individuals often use productivity software such as e-mail applications, word processing applications, spreadsheet applications, presentation applications, and other such productivity applications, as part of their work day to complete their tasks. For example, users may use an e-mail application to send e-mail messages. Many organizational workers collaborate with other individuals internally, and also externally. Productivity software may be utilized to assist with the collaboration. For instance, users may schedule meetings using a calendar application.

While collaboration is often necessary and a value-add to organizations, too much collaboration may have a negative effect on individual and/or organizational efficiency. For example, if workers are spending too much time in meetings, they may not be able to complete their tasks. In addition, some tasks may require an individual to be able to focus, and constant interruptions may cause an individual to be less focused. In some situations, an individual or a group of individuals may experience “collaboration overload,” where they are unable to effectively manage their workload and/or tasks due to too much collaboration.

### Overview

Technology is disclosed herein for operating a behavior change management service that allows a user to analyze productivity service data to identify individuals experiencing collaboration overload, time management issues, or other issues. For example, the behavior change management service, also referred to herein as change management service, may collect productivity service data from a productivity service and/or a productivity service application. In some implementations, the change management service may collect data related to the quantity of the time spent in meetings. The behavior change management service may also collect information about workers working after-hours. This may be accomplished by monitoring when workers log in and/or out of their computers or e-mail account.

In an implementation, the behavior change management service presents an analyst or administrative user with a set of pre-determined and pre-ordered natural language questions that were specifically developed to identified collaboration issues. The set of natural language questions helps the user to identify and select a behavior or issue for the behavior change management plan. For example, an organization may wish to identify individuals that spend too much time in meetings. The behavior change management service processes the collected service data to identify a behavior or issue. In some implementations, the analyst or administrative user will be presented with data corresponding to the natural language questions, allowing the analyst to filter and sort the data to identify individuals for participation in the behavior change management program. For example, if the analyst selects the question: “Which groups spend the most time in meetings?” The behavior change management service may process the productivity service data for the organization and display a graph, graphic, or other illustration that shows total meeting time for each group, such as: engineering, finance, human resources, marketing, operations, accounting, sales, security, etc. Another issue related to collaboration overload may be redundant meetings. To identify redundant meetings, the behavior change management service may also analyze data from a calendar application identify individuals that routinely attend the same meetings.

In some implementations, the behavior change management service may determine a threshold for time spent in meetings on a weekly or monthly basis when an individual's effectiveness decreases from “over collaboration.” The change management service identifies a group of individuals with a weekly or monthly overall time spent in meetings that is over the threshold. These are the individuals that may be selected for inclusion in the behavior change management program. This allows for individuals with similar collaboration issues to work on a shared change management program to develop new habits.

In some implementations, the behavior change management service communicates directly with the productivity application. For example, the behavior change management service may be connected via a plug-in, add-on, application programming interface, extension, and/or other means of communication. In some examples, the productivity applications may automatically transfer user data to the change management service, which stores the data. In other examples, the change management service sends a request for the data.

Once a group of individuals with the same collaboration issue is identified, the behavior change management service application develops a change management program based on the identified collaboration issue(s), organizational goals, timeframe, and/or other factors that may be tailored for each organization. For example, the behavior change management program may set boundaries and/or goals for time spent in meetings on a daily, weekly, and/or monthly basis. In some implementations, the behavior change management service may prevent the worker from scheduling additional meetings once the allotted meeting time has been scheduled/used. In another implementation, the behavior change management service may notify the participant once the weekly meeting time reaches a threshold. The notification may be an email, pop-up message, text message, SMS message, or other notification.

In addition, the behavior change management program may set weekly or monthly goals and/or milestones for the program participants and monitor and/or track each participants' progress. The change management participants may receive notifications about their progress, additionally, group statistics may be shared, without disclosing participants' identities. In some implementations, workers may interact with a dashboard to view their statistics and receive information regarding the behavior change management program.

The behavior change management service allows organizations to diagnose issues and areas for improvement. The behavior change management service identifies target populations for participation in the behavior change management programs, designs and deploys the change management programs, and tracks each individual's progress through the behavior change management program opportunity areas

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational environment and an exemplary scenario in an implementation of a behavior change management service.

FIG. 2 illustrates a behavior change management service process in an implementation.

FIG. 3 illustrates another operational environment in an implementation.

FIG. 4 illustrates an operational scenario in an implementation.

FIGS. 5A and 5B illustrate an operational scenario in an implementation.

FIG. 6A-D illustrate an operational scenario in an implementation.

FIG. 7 illustrates a computing device suitable for implementing the behavior change management technology disclosed herein, including any of the architectures, environments, elements, processes, and operational scenarios and sequences illustrated in the Figures and discussed below in the Technical Disclosure.

### TECHNICAL DISCLOSURE

Technology is disclosed herein for implementing a behavior change management service that interacts with various applications in support of workplace analytics. The behavior change management service, which may be implemented on one or more server computers in the context of a data center, that communicates with a variety of applications on end-user devices. The applications produce and send user data to the behavior change management service to be stored in a repository and analyzed. The repository may be maintained by the behavior change management service, although such responsibilities may be offloaded to or shared with other services.

The user data or productivity service data may be implemented in the form of files, data streams, or other suitable data structures. The workers' productivity service data may also include metadata indicative of their source, such as the identity of the application associated with the service data, the activity associated with the service data, the associated worker, and the time the worker used or accessed the application. Service data may be stored according to application and/or worker. While the service data may be user-specific, the data may also be aggregated on a per-group or per-team basis or in some other manner.

In operation, the change management service presents an administrative or analyst with a series of natural language questions to assist the analyst in identifying collaboration issues within the organization. The behavior change management service presents the analyst with graphical data corresponding to each natural language question. The behavior change management service processes the service data from the productivity applications to identify workers with similar collaboration issues. In some examples, the analyst is presented with a series of natural language questions, as the analyst answers the questions, the behavior change management service processes the relevant data to identify a group of workers.

In some examples, a productivity service may aggregate and store the service data for the organization, and the change management service requests the relevant service data from the productivity service. The requests may specify, for example, users (i.e. organization, groups, and/or individual users), the type of relevant activity (e.g. scheduled meetings), a time period, workers to exclude (e.g. contractors and interns), etc.

In some implementations, the behavior change management service analyzes the productivity service data to identify the individuals and/or groups with service data above a threshold. For example, the change management service may determine that when workers spend more than ten hours/week in meetings efficiency decreases, therefore, the behavior change management service identifies the individuals with an overall time in meetings that exceeds ten hours/week. In some examples, the change management service may identify organizational groups (e.g. accounting or engineering) that have a certain of percentage of workers with service data above the threshold. The behavior change management program may be deployed to the entire group or only to the individuals with service data above the threshold.

Collaboration overload reflects one or more interrelated organizational issues, such as lack of role clarity, poor e-mail and meeting norms, working across time zones, burdensome processes, etc. Leading indicators of collaboration overload are too many hours spent in meeting, too much time spent on e-mails, too many e-mails, and too much time spent working after hours. Behavior change management service 109 provides a targeted diagnostic to assist organizations in discovering individuals and/or groups experiencing collaboration overload. However, the different groups may have different causes for their collaboration overload. The service further narrows down and identifies which aspects of collaboration overload should be addressed through behavior change management programs. In this manner, a technical advance is achieved whereby workers with collaboration and/or other behavioral issues can be quickly and efficiently identified. Organizational users may explore root causes related to each collaboration issue. Furthermore, the behavior change management service allows the organization to monitor and track workers' progress during and after the behavior change management program.

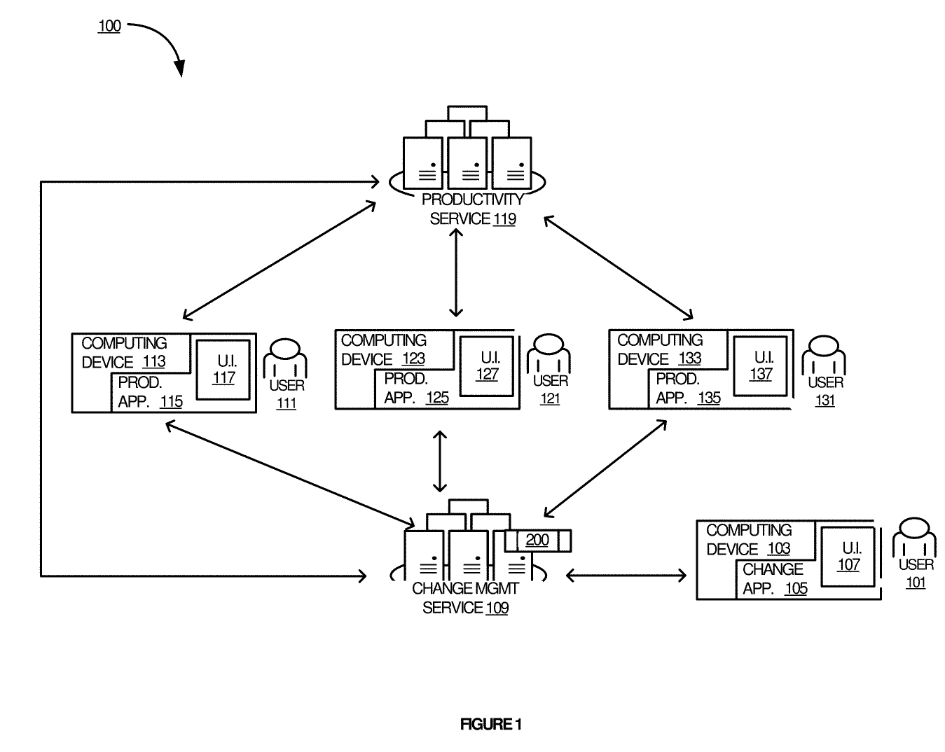

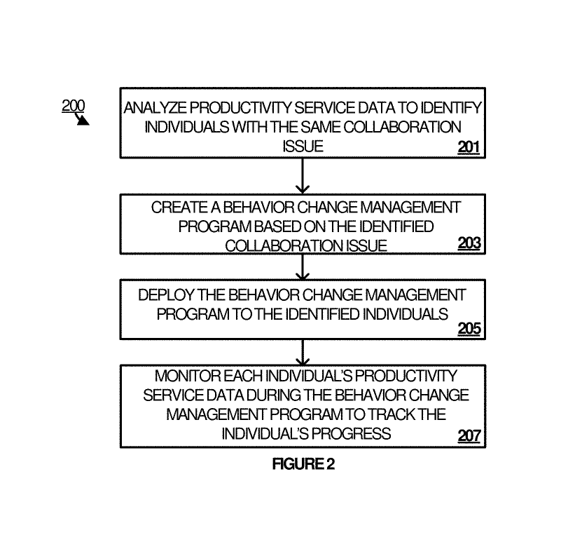

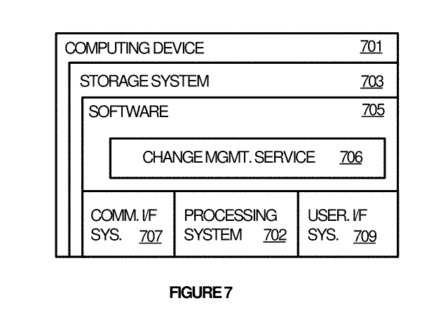

FIG. 1 illustrates an operational environment 100 in an implementation. Operational environment 100 includes behavior change management service 109 from which a change management program may be developed, and deployed. Change management service 109 may store users' service data. Behavior change management service 109 may be implemented as a stand-alone service or it may be integrated with other services of any type. Change management service 109 may be implemented in one or more data centers (physical or virtual), and on one or more computing systems, of which computing system 700 in FIG. 7 is representative.

User 101 accesses behavior change management service 109 using computing device 103, which runs behavior change management application 105. Computing device 103 may also be implemented on one or more computing systems, of which computing system 700 in FIG. 7 is representative.

In some examples, user 101 is an administrator or analyst user. User 101 interacts with behavior change management service 109 and change management application 105 using user interface (UI) 107. For example, the set of natural language questions may be presented to user 101 via UI 107. User 111 uses productivity application 115 on computing device 113, which includes UI 117. User 121 uses productivity application 125 on computing device 123, which includes UI 127. User 131 uses productivity application 135 on computing device 133, which includes UI 137. In some examples, productivity applications 115, 125, and 135 comprise the same application. In other examples, productivity application 115 comprises a calendar application, productivity application 125 comprises an e-mail application, and productivity application 135 comprises a word processing application. In some implementations, users 111, 121, and 131 may comprise workers in a same organizational group or unit, such as accounting. Computing devices 103, 113, 123, and 133 may comprise one or more computing systems, of which computing system 700 in FIG. 7 is representative.

Productivity applications 115, 125, and 135 communicate with productivity service 119, productivity service 119 may comprise a suite of productivity applications of which MICROSOFT OFFICE 365® is an example. Productivity service 119 may be implemented as a stand-alone service or it may be integrated with other services of any type. Productivity service 119 may be implemented in one or more data centers (physical or virtual), and on one or more computing systems, of which computing system 700 in FIG. 7 is representative. Behavior change management service 109 may also communicate directly with productivity applications 115, 125, and 135, as illustrated. In some implementations, behavior change management service 109 communicates with productivity service 109, which communicates with productivity applications 115, 125, and 135.

Productivity applications 115, 125, and 135 illustrated in FIG. 1 are representative of the applications with which productivity service 119 may interact. Examples of applications 115, 125, and 135 include, but are not limited to, e-mail applications, calendar applications, word processing applications, presentation applications, meeting applications, spreadsheet applications, note-taking applications, social networking applications, communication applications, messaging applications, gaming applications, browser applications, and any other suitable application, combination, or variation thereof. Each of applications 115, 125, and 135 may be implemented as a natively installed and executed application, a browser-based application, an applet, an add-in application, a streamed or streaming application, a mobile application, or any other type of software application. Applications 115, 125, and 135 may be employed on a variety of devices, such as desktop computers, laptops, tablets, mobile phones, gaming devices, wearable devices, or any other suitable computing device, of which computing system 700 in FIG. 7 may be broadly representative.

Behavior change management service process 200 may be employed in the context of developing and deploying a behavior change management program. Behavior change management service process 200 may be implemented in program instructions in the context of any of the software applications, modules, components, or other such programming elements that comprise behavior change management service 109. The program instructions direct the underlying physical or virtual computing system or systems that provide the behavior change management service to operate as follows.

Broadly speaking, behavior change management service 109 first analyzes productivity service data to identify individuals with the same collaboration issue (step 101). For example, behavior change management service may identify individuals based on overall meeting hours, overall time spent working after hours, overall focus hours, meeting impact, etc. In some implementations, user 101 may set filters in behavior change management application 105 via interacting with UI 107.

User 101 may also interact with behavior change management service 109 through change management application 105 to toggle through a set of natural language questions related to the collaboration issue. Each question is associated with an analysis of data relevant to the questions. When user 101 selects a specific question, the associated analysis and data are displayed, which helps user 101 to identify individuals with the collaboration issue and further narrow down the causes of the issue.

In some implementations, user 101 may select which metric(s) she thinks is/are the key indicator(s) of collaboration overload, so that behavior change management service 109 can analyze the relevant service data. User 101 may submit the identified individuals and their corresponding collaboration issue to an administrator user for program enrollment. In some implementations, the administrator user will receive an email notification of new groups for program enrollment.

Next, behavior change management service 109 creates a change management program for the identified collaboration issue (step 203). For instance, the behavior change management program may be implemented to help workers spend less time in meetings or less time working after hours. In order to help workers, adapt habits or change their behavior, behavior change management service 109 implements a change management program. The change management program may set boundaries for metrics relevant to the habit or set of habits to be adopted. In addition, the behavior change management program may set boundaries or thresholds for the overall time spent in meetings, the overall time spent working hours, an individual's overall focus time, etc.

The behavior change management program may be customized for each participant. For example, if the goal is to reduce an individual's overall time spent in meetings from the worker's current overall time spent in meetings to a maximum of seven hours/week, each individual worker's weekly and monthly goals may be determined based on their current overall meeting time per week. For instance, if one worker currently spends twenty hours per week in meetings, her weekly and monthly goals may differ from a worker that currently spends twelve hours in meetings per week. Therefore, the worker that currently spends twenty hours per week in meetings can proportionally reduce their meeting time rather than requiring them to drastically reduce their overall meeting time, which would be more difficult to accomplish and likely result in failure to adopt new habits or the behavior change necessary to sustain the reduced overall meeting time long-term.

Behavior change management service 109 deploys the behavior change management program (step 205). In some implementations, the identified individuals will receive a welcome letter informing them of their enrollment in a behavior change management program. Behavior change management service 109 monitors each program participant's productivity service data during the course of the program to monitor their progress (step 207).

FIG. 3 illustrates another operational environment in an implementation, represented by operational environment 300. Operational environment 300 includes behavior change management service 109 from which a behavior change management program may be selected, developed, and deployed.

In an operational scenario, behavior change management application 105 renders a user interface 107 with which user 101 may interact to access the functions and features of the application. In some implementations, user 101 may identify individual workers for a behavior change management program based on similar collaboration issues. For example, an organization may wish to identify individuals that spend too much time working after hours. Once the individuals are identified, user 101 set-ups a behavior change management program. In some examples, the identified individuals and information about their collaboration issue is sent to a program administrator for enrollment in a behavior change management program. The behavior change management program may define boundaries, milestones, goals and duration. User 101 may track individual workers' progress during his or her behavior change management program, in addition, each participant may track his or her own progress, which may also be compared to other participants' progress, although program participation will be confidential.

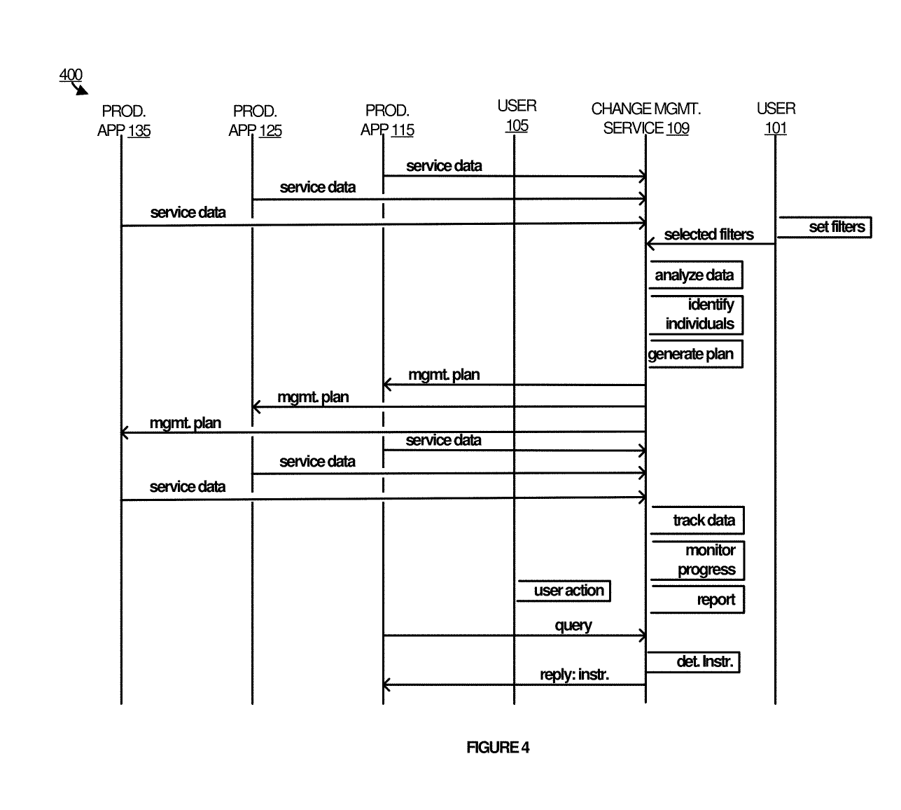

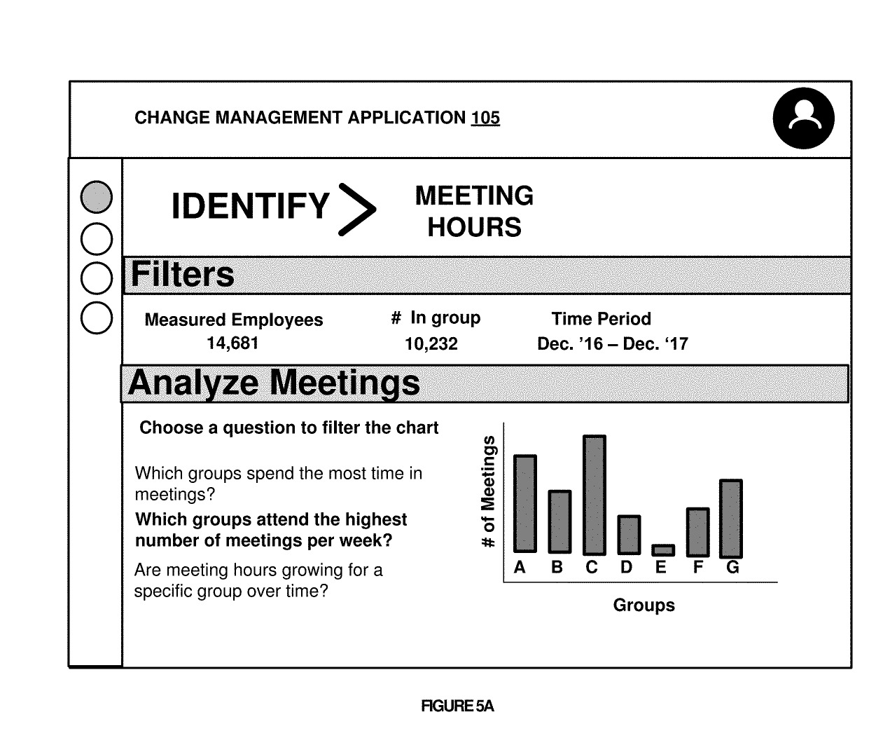

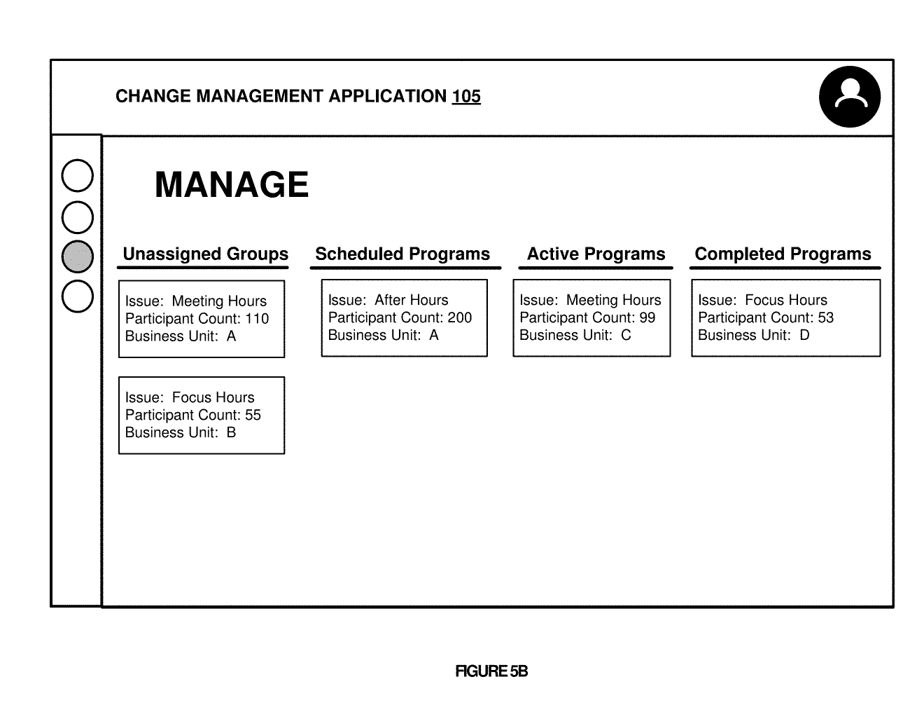

FIG. 4 illustrates one operational scenario. In operational scenario 400, productivity applications 115, 125, and 135 transfer service data associated with individual users to behavior change management service 109. User 101 selects a collaboration issue, such as meeting hours, after hours, focus hours, and hours spent on a task (e.g. email) and sets filters. Change management service 109 analyzes the relevant service data to identify individuals with the selected collaboration issue. In some implementations, change management service 109 processes the service data and graphically presents the service data to user 101. For example, user 101 may select the natural language question “Which group spends the most time working after hours?” and behavior change service 109 generates and displays a graph for the total time spent after hours broken down by organizational group.

In some implementations, behavior change management service 109 analyzes the service data to identify the individuals and/or groups with service data above a threshold. For example, if user 101 selected meeting hours, change management service 109 may identify the individuals with an overall time in meetings that exceeds a threshold. In some examples, the change management service may identify organizational groups (e.g. accounting or engineering) that have a certain of percentage of workers with meeting hours above the threshold.

Behavior change management service 109 generates a behavior change management program and deploys the program to the identified individuals. During the program, behavior change management service 109 receives service data for the program participants, behavior change management service 109 monitors the individuals' service data to track each individual's progress in the program. Program participants may have a program dashboard that allows them to view their progress and learn about new habits to assist them in reaching and maintaining their program goals. Although participants' information is kept confidential, participants' progress may be compared to the group's overall progress to further motivate the program participants.

In some implementations, behavior change management service 109 may actively interact with a productivity application and/or the user. For example, if a program participant's weekly meeting time has been reached, behavior change management service 109 may send a notification to the user that the weekly allotted meeting time has been reached. In other examples, behavior change management service 109 may even prevent the user from scheduling any additional meetings until the next week. In other examples, behavior change management service 109 may identify redundant meetings and suggest consolidating or cancelling the redundant meetings.

FIGS. 5A and 5B illustrates another operational scenario pertaining to behavioral change management service within an organization.

FIG. 5A illustrates the user interface for the behavior change management application 105, where an analyst or administrative user identifies a group of individuals with similar collaboration issues. For example, the analyst may apply filters to the analysis. For instance, the analyst may wish to exclude certain employees (e.g. contractors and/or interns). The analyst may also wish to specify a time period for the identification. FIG. 5A also illustrates the natural language questions in the behavior change management service that assist the analyst in sorting and filtering the cause of the collaboration issue allowing individuals with similar root causes to be grouped together.

FIG. 5B illustrates the user interface for the behavior change management application 105 for the administrative user. The administrative user manages the behavior change management programs for the organization. In some implementation, one administrative user may manage behavior change management programs for multiple organizations. In this example, the analyst user (may be the same user) has identified two groups for a behavior change management program, these two groups are listed under the “Unassigned Groups” heading. There is one group that has a scheduled program that has not started yet, listed under “Scheduled Programs” heading. There is one group that is in the process of completing their program, listed under “Active Programs.” Finally, there is one group that has completed their behavior change management program, listed under the heading, “Completed Programs.”

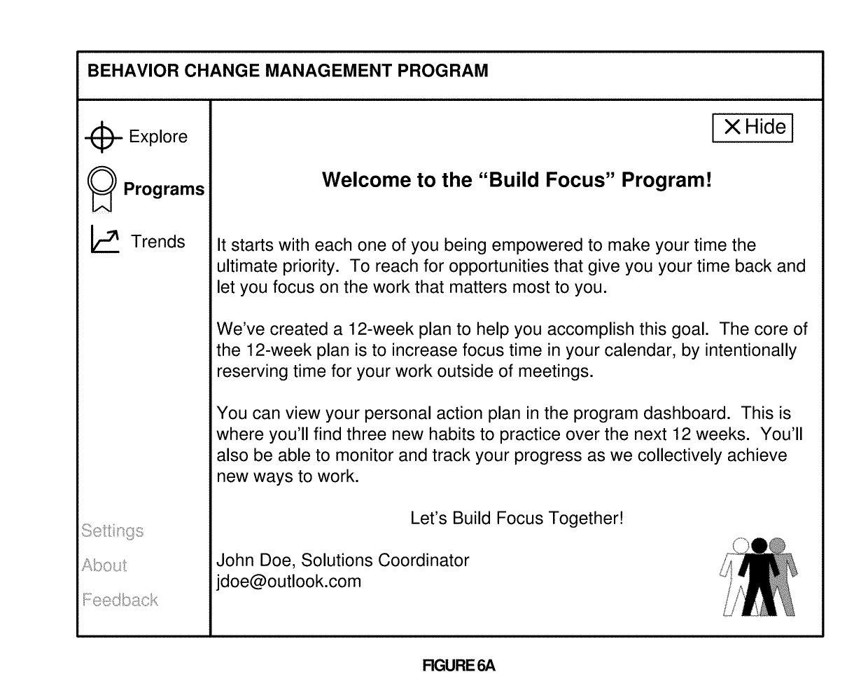

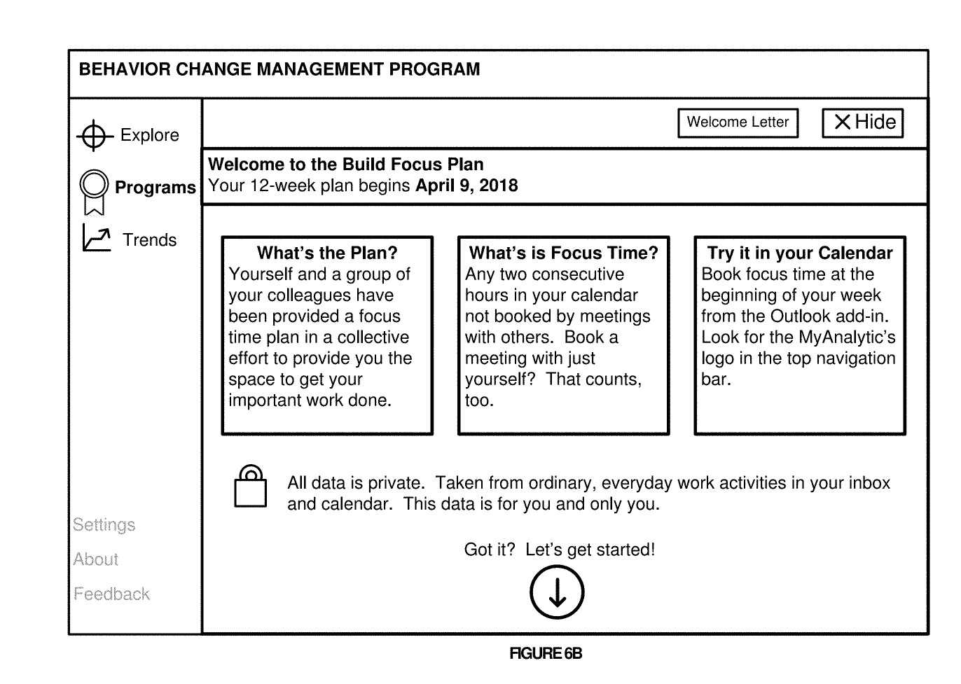

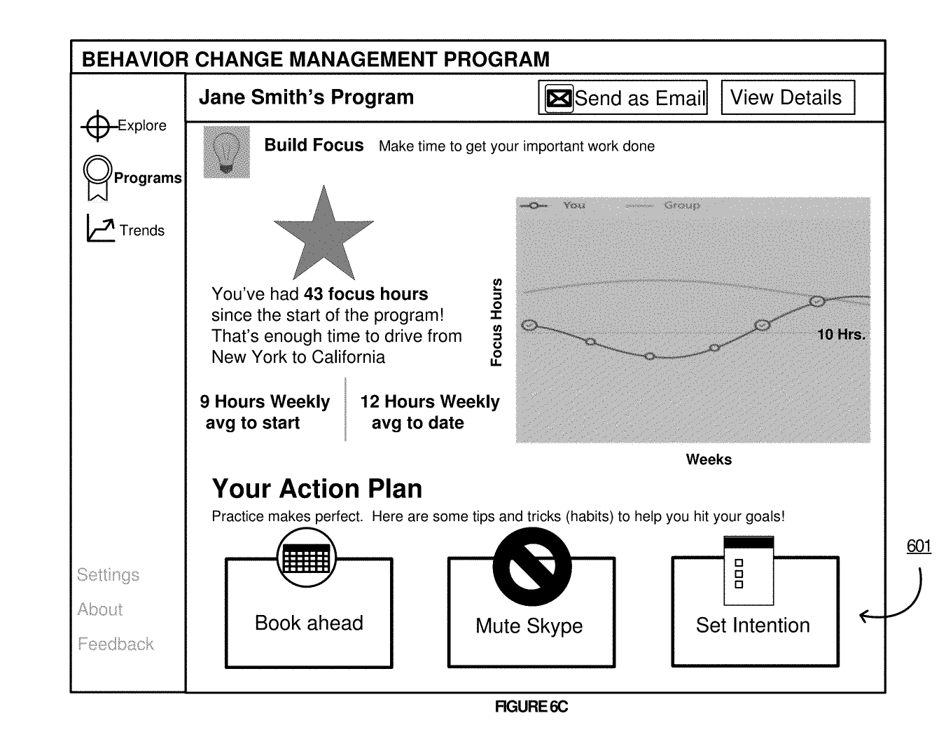

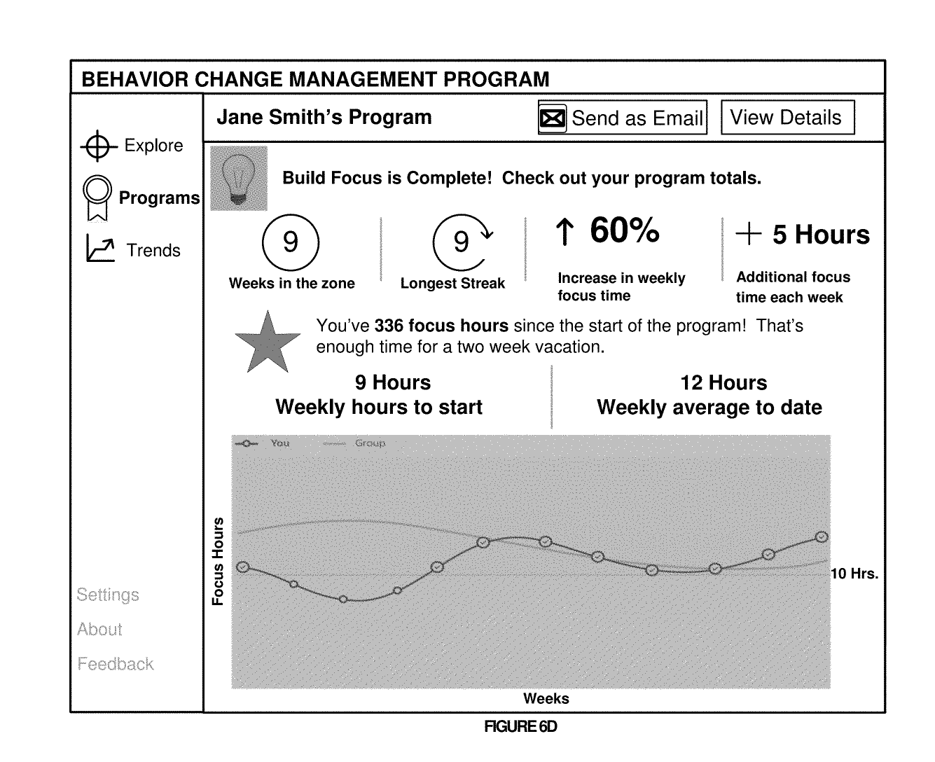

FIG. 6 illustrates another operational scenario pertaining to a behavioral change management program. FIG. 6A illustrates the user interface for the behavior change management application for the participant in the behavior change management program. The program participant may receive the welcome letter illustrated in FIG. 6A telling her that she has been enrolled in a behavior change program and now has access to the behavior change management application.

FIG. 6B illustrates an informational page. The page includes information about the plan, describes focus time, and gives tips for increasing focus time. Program participants are informed that their data and information will be kept private. Although statistics for the group may be displayed and used for comparison, participants' identities will be kept confidential.

FIG. 6C illustrates the user interface for the behavior change management application for a program participant. FIG. 6C illustrates the dashboard for a program participant that is halfway through his 12-week program. The dashboard displays the participant's progress. As illustrated, the participant started the program with an average of nine (9) hours of focus time. Working through the program, the same user has increased his weekly focus time to twelve (12) hours. In addition, the user has a total of forty-three (43) hours of focus time from the start of the program to date. The behavior change management program also provides an action plan that includes habits that the participant can try to adopt to help him increase his total amount of focus time. For example, the user may book focus time into his calendar similar to a meeting. The user may also try muting applications such as SKYPE® or e-mail during scheduled focus time.

FIG. 6D illustrates the dashboard for a program participant that has completed the 12-week program. As illustrated, the user was able to increase his focus time by 60%, which added an additional five (5) hours of focus time per week. The user may also send the program details to himself or someone else via email.

FIG. 7 illustrates computing device 701, which is representative of any system or collection of systems in which the various applications, services, scenarios, and processes disclosed herein may be implemented. Examples of computing device 701 include, but are not limited to, smart phones, laptop computers, tablet computers, desktop computers, hybrid computers, gaming machines, virtual reality devices, smart televisions, smart watches and other wearable devices, as well as any variation or combination thereof. Other examples may include server computers, rack servers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709. Processing system 702 is operatively coupled with storage system 703, communication interface system 707, and user interface system 709.

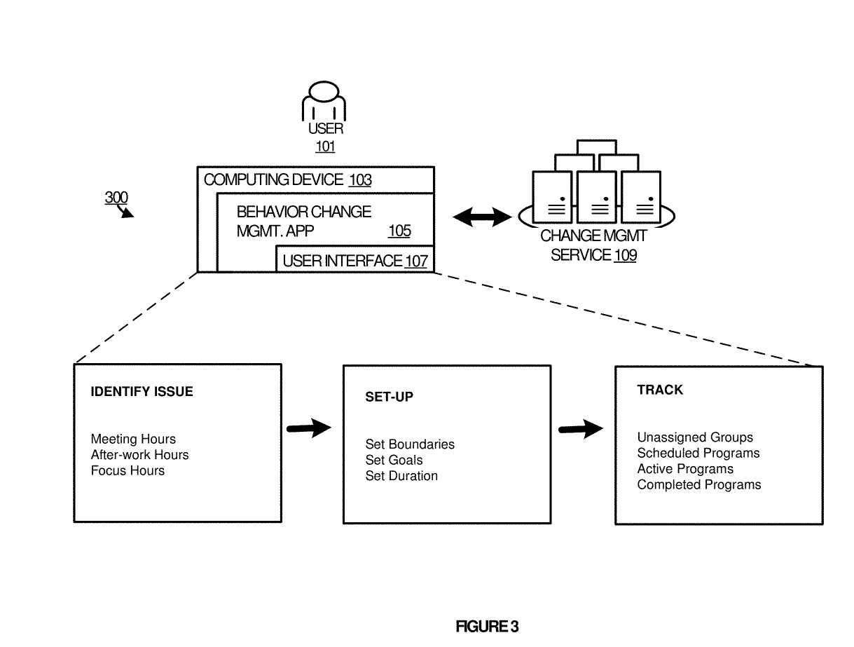

Processing system 702 loads and executes software 705 from storage system 703. Software 705 includes behavior change management application 706, which is representative of the behavior change management applications discussed with respect to the preceding FIGS. 1-6, including behavior change management application 105. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or other suitable storage media, except for propagated signals. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions for implementing provisioning notes service process 200.

In general, software 705 may, when loaded into processing system 702 and executed, transform a suitable apparatus, system, or device (of which computing system 701 is representative) overall from a general-purpose computing system into a special-purpose computing system customized to process note items and respond to queries. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here.

User interface system 709 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTMLS, XML (extensible markup language), JavaScript, JSON (JavaScript Object Notation), and AJAX (Asynchronous JavaScript and XML), as well as any other suitable protocol, variation, or combination thereof.

### EXAMPLE 1

A method of operating a behavior change management service, the method comprising: analyzing productivity service data to identify individuals with a collaboration issue; creating a behavior change management program based on the identified collaboration issue; deploying the behavior change management program to the identified individuals; and monitoring each individual's productivity service data during the behavior change management program to track each individual's progress.

### EXAMPLE 2

The method of Example 1 wherein the collaboration issue comprise an overall time spent in meetings.

### EXAMPLE 3

The method of Examples 1-2 wherein the overall time spent in meeting further comprises the overall time spent in redundant meetings.

### EXAMPLE 4

The method of Examples 1-3 wherein the collaboration issue comprises a quantity of meetings.

### EXAMPLE 5

The method of Examples 1-4 wherein the collaboration issue comprises the overall time spent working after hours.

### EXAMPLE 6

The method of Examples 1-5 wherein the collaboration issue comprises and overall focus time.

### EXAMPLE 7

The method of Examples 1-6 further comprising: receiving a query from the productivity application; processing the query to determine a behavior change management instruction; and transferring the behavior change management instruction to the productivity application.

### EXAMPLE 8

A computing apparatus comprising: one or more computer readable storage media; a processing system operatively coupled with the one or more computer readable storage media; and program instructions stored on the one or more computer readable storage media that, when read and executed by the processing system, direct the processing system to at least: analyze productivity service data to identify individuals with a collaboration issue; create a behavior change management program based on the identified collaboration issue; deploy the behavior change management program to the identified individuals; and monitor each individual's productivity service data during the behavior change management program to track each individual's progress.

### EXAMPLE 9

The computing apparatus of Example 8 wherein the collaboration issue comprises an overall time spent in meetings.

### EXAMPLE 10

The computing apparatus of Examples 8-9 wherein the overall time spent in meetings further comprises an overall time spent in redundant meetings.

### EXAMPLE 11

The computing apparatus of Examples 8-10 wherein the collaboration issue comprises a quantity of meetings.

### EXAMPLE 12

The computing apparatus of Examples 8-11 wherein the collaboration issue comprises an overall time spent working after hours.

### EXAMPLE 13

The computing apparatus of Examples 8-12 wherein the collaboration issue comprises an overall focus time.

### EXAMPLE 14

The computing apparatus of Examples 8-13 wherein the program instructions further direct the processing system to: receive a query from the productivity application; process the query to determine a behavior change management instruction; and transfer the behavior change management instruction to the productivity application.

### EXAMPLE 15

One or more computer readable storage media having a local application including a suggestion service stored thereon comprising program instructions that, when read and executed by a processing system, direct the processing system to at least: analyze productivity service data to identify individuals with a collaboration issue; create a behavior change management program based on the identified collaboration issue; deploy the behavior change management program to the identified individuals; and monitor each individual's productivity service data during the behavior change management program to track each individual's progress.

### EXAMPLE 16

The one or more computer readable storage media of Example 15 wherein the collaboration issue comprises an overall time spent in meetings.

### EXAMPLE 17

The one or more computer readable storage media of Examples 15-16 wherein the overall time spent in meetings further comprises an overall time spent in redundant meetings.

### EXAMPLE 18

The computing apparatus of Examples 15-17 wherein the collaboration issue comprises a quantity of meetings.

### EXAMPLE 19

The computing apparatus of Examples 15-18 wherein the collaboration issue comprises an overall time spent working after hours.

### EXAMPLE 20

The computing apparatus of Examples 15-19 wherein the collaboration issue comprises an overall focus time.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A method of operating a behavior change management service, the method comprising:
analyzing productivity service data associated with users of a productivity service application to identify one or more individuals with a collaboration issue;
creating a behavior change management program based on the identified collaboration issue;
deploying the behavior change management program to the one or more individuals with the identified collaboration issue; and
monitoring each individual's productivity service data during the behavior change management program to track each individual's progress.

2. The method of claim 1 wherein the collaboration issue comprises an overall time spent in meetings.

3. The method of claim 2 wherein the overall time spent in meetings is further broken down into overall time spent in redundant meetings.

4. The method of claim 1 wherein the collaboration issue comprises a quantity of meetings.

5. The method of claim 1 wherein the collaboration issue comprises an overall time spent working after hours.

6. The method of claim 1 wherein the collaboration issue comprises an overall focus time.

7. The method of claim 1 further comprising:
receiving a query from the productivity service application;
processing the query to determine a behavior change management instruction; and
transferring the behavior change management instruction for delivery to the productivity service application.

8. A computing apparatus comprising:
one or more computer readable storage media;
a processing system operatively coupled with the one or more computer readable storage media; and
a behavior change management program comprising program instructions stored on the one or more computer readable storage media that, when read and executed by the processing system, direct the processing system to at least:
analyze productivity service data associated with users of a productivity service application to identify one or more individuals with a collaboration issue;
create a behavior change management program based on the identified collaboration issue;
deploy the behavior change management program to the one or more individuals with the identified collaboration issue; and
monitor each individual's productivity service data during the behavior change management program to track each individual's progress.

9. The computer apparatus of claim 8 wherein the collaboration issue comprises an overall time spent in meetings.

10. The computer apparatus of claim 9 wherein the overall time spent in meetings further comprises overall time spent in redundant meetings.

11. The computer apparatus of claim 8 wherein the collaboration issue comprises a quantity of meetings.

12. The computer apparatus of claim 8 wherein the collaboration issue comprises an overall time spent working after hours.

13. The computer apparatus of claim 8 wherein the collaboration issue comprises an overall focus time.

14. The computer apparatus of claim 8 wherein the program instructions further direct the processing system to:
receive a query from the productivity service application;
process the query to determine a behavior change management instruction; and
transfer the behavior change management instruction for delivery to the productivity service application.

15. One or more computer readable storage media having program instructions stored thereon comprising a software application that, when read and executed by a processing system, direct the processing system to at least:
analyze productivity service data associated with users of a productivity service application to identify one or more individuals with a collaboration issue;
create a behavior change management program based on the identified collaboration issue;
deploy the behavior change management program to the one or more individuals with the identified collaboration issue; and
monitor the productivity service data associated with the one or more individuals with the identified collaboration issue during the behavior change management program to track each individual's progress.

16. The one or more computer readable storage media of claim 15 wherein the collaboration issue comprises an overall time spent in meetings.

17. The one or more computer readable storage media of claim 16 wherein the overall time spent in meetings further comprises an overall time spent in redundant meetings.

18. The one or more computer readable storage media of claim 15 wherein the collaboration issue comprises a quantity of meetings.

19. The one or more computer readable storage media of claim 15 wherein the collaboration issue comprises an overall time spent working after hours.

20. The one or more computer readable storage media of claim 15 wherein the collaboration issue comprises an overall focus time.
